(19) United States
(12) Patent Application Publication
(10) Pub. No.: US 2026/0202606 A1
(43) Pub. Date: Jul. 16, 2026

(54) LIGHT SOURCE MODULE AND DISPLAY APPARATUS

(71) Applicant: HannStar Display Corporation, Taipei City (TW)

(72) Inventors: Yu-Chi Chiao, Taipei City (TW); Yu-Cheng Lin, Taipei City (TW); Chun-Ming Hsu, Taipei City (TW); Yen-Chung Chen, Taipei City (TW); Hsin Liang Lai, Taipei City (TW)

(73) Assignee: HannStar Display Corporation, Taipei City (TW)

(21) Appl. No.: 19/199,371

(22) Filed: May 5, 2025

(30) Foreign Application Priority Data
Jan. 13, 2025 (CN) 202510050250.4

(51) Int. Cl. F21V 8/00; G02F 1/13357

(52) U.S. Cl. CPC G02B 6/0091; G02B 6/0068; G02B 6/0083; G02F 1/133615

(57) ABSTRACT

A light source module includes a light guide plate, a first light source and a second light source. The light guide plate has a light incident surface and a first surface and a second surface connected to the light incident surface and opposite to each other. The first light source and the second light source are disposed on one side of the light incident surface of the light guide plate. The first light source includes a first circuit board and a plurality of first light-emitting elements disposed thereon and adapted to emit a first light beam. The second light source includes a second circuit board and a plurality of second light-emitting elements disposed thereon and adapted to emit a second light beam. The first light-emitting elements and the second light- emitting elements are located between the first circuit board and the second circuit board.

### CROSS-REFERENCE TO RELATED APPLICATION

This application claims the priority benefit of China application serial no. 202510050250.4, filed on January 13, 2025. The entirety of the above-mentioned patent application is hereby incorporated by reference herein and made a part of this specification.

### BACKGROUND

### TECHNICAL FIELD

The disclosure relates to an optical module and an electronic apparatus, and in particular, to a light source module and a display apparatus.

### DESCRIPTION OF RELATED ART

For non-emissive display panel, a light source module used to provide illumination light is indispensable. Among them, edge-lit light source modules are gradually becoming mainstream due to their ability to make display apparatuses thinner and lighter. Typically, an edge-lit light source module includes a light guide plate with a light source disposed on the side of the light guide plate. In order to meet requirements of adjusting the color temperature of the illumination light, the light source can be composed of light-emitting elements with different color temperatures. However, these light-emitting elements are not continuously arranged along the light incident side of the light guide plate, and variations in brightness between the light-emitting elements of different color temperatures can lead to uneven brightness and chromaticity, resulting in hotspots on the light output surface of the light guide plate. On the other hand, due to the limited edge space of the light guide plate, increasing the light output brightness of the light source module requires enlarging the size of the light guide plate to accommodate more light-emitting elements, which makes it more challenging to achieve a slim and lightweight appearance of the display apparatus.

### SUMMARY

The disclosure provides a light source module and a display apparatus with better light output uniformity and higher density of configuration of light-emitting elements.

A light source module of the disclosure includes a light guide plate, a first light source and a second light source. The light guide plate has a light incident surface and a first surface and a second surface connected to the light incident surface and opposite to each other. The first light source is disposed on one side of the light incident surface of the light guide plate and includes a first circuit board and a plurality of first light-emitting elements. The plurality of first light- emitting elements are disposed on a first board surface of the first circuit board and are adapted to emit a first light beam toward the light incident surface. The second light source is disposed on one side of the light incident surface of the light guide plate and includes a second circuit board and a plurality of second light-emitting elements. The plurality of second light-emitting elements are disposed on a second board surface of the second circuit board and are adapted to emit a second light beam toward the light incident surface. The plurality of first light-emitting elements and the plurality of second light-emitting elements are located between the first circuit board and the second circuit board.

In an embodiment of the disclosure, in a direction perpendicular to the first board surface and the second board surface, the plurality of first light-emitting elements of the light source module overlap the plurality of second light-emitting elements respectively.

In an embodiment of the disclosure, in a direction perpendicular to the first board surface and the second board surface, one of the plurality of first light-emitting elements of the light source module overlaps one of the plurality of second light-emitting elements. The one of the plurality of first light-emitting elements is staggered relative to the one of the plurality of second light- emitting elements.

In an embodiment of the disclosure, the one of the plurality of first light-emitting elements of the light source module also overlaps another one of the plurality of second light- emitting elements. The one of the plurality of second light-emitting elements also overlaps another one of the plurality of first light-emitting elements.

In an embodiment of the disclosure, a color of the first light beam of the light source module is different from a color of the second light beam.

In an embodiment of the disclosure, the first circuit board of the light source module extends to one side of the first surface of the light guide plate so that the first board surface faces the first surface. The second circuit board extends to one side of the second surface of the light guide plate so that the second board surface faces the second surface.

In an embodiment of the disclosure, the plurality of first light-emitting elements of the light source module are arranged along an arrangement direction parallel to the light incident surface, the first surface and the second surface. The plurality of second light-emitting elements are arranged along the arrangement direction. In the arrangement direction, any one of the plurality of first light-emitting elements and any one of the plurality of second light-emitting elements respectively have a first element width and a second element width. The first element width is different from the second element width.

In an embodiment of the disclosure, the first light source of the light source module further includes a plurality of third light-emitting elements disposed on the first board surface of the first circuit board and are adapted to emit a third light beam toward the light incident surface. The plurality of first light-emitting elements and the plurality of third light-emitting elements are alternately arranged along an arrangement direction parallel to the light incident surface, the first surface and the second surface. The second light source further includes a plurality of fourth light-emitting elements disposed on the second board surface of the second circuit board and are adapted to emit a fourth light beam toward the light incident surface. The plurality of second light-emitting elements and the plurality of fourth light-emitting elements are alternately arranged along the arrangement direction. A color of the third light beam is different from a color of the first light beam. A color of the fourth light beam is different from a color of the second light beam.

In an embodiment of the disclosure, in a direction perpendicular to the first board surface and the second board surface, the plurality of first light-emitting elements of the light source module overlap the plurality of second light-emitting elements respectively. The plurality of third light-emitting elements overlap the plurality of fourth light-emitting elements respectively. The color of the first light beam is different from the color of the second light beam. The color of the third light beam is different from the color of the fourth light beam.

In an embodiment of the disclosure, the color of the first light beam of the light source module is the same as the color of the fourth light beam. The color of the second light beam is the same as the color of the third light beam.

In an embodiment of the disclosure, the first light source of the light source module further includes a plurality of fifth light-emitting elements disposed on the first board surface of the first circuit board and are adapted to emit a fifth light beam toward the light incident surface.

The plurality of first light-emitting elements, the plurality of third light-emitting elements and the plurality of fifth light-emitting elements are alternately arranged along the arrangement direction.

The second light source further includes a plurality of sixth light-emitting elements disposed on the second board surface of the second circuit board and adapted to emit a sixth light beam toward the light incident surface. The plurality of second light-emitting elements, the plurality of fourth light-emitting elements and the plurality of sixth light-emitting elements are alternately arranged along the arrangement direction. A color of the fifth light beam is different from the color of the first light beam and the color of the third light beam. A color of the sixth light beam is different from the color of the second light beam and the color of the fourth light beam.

In an embodiment of the disclosure, in a direction perpendicular to the first board surface and the second board surface, one of the plurality of first light-emitting elements of the light source module overlaps one of the plurality of second light-emitting elements and one of the plurality of sixth light-emitting elements. One of the plurality of third light-emitting elements overlaps the one of the plurality of second light-emitting elements and one of the plurality of fourth light- emitting elements. One of the plurality of fifth light-emitting elements overlaps the one of the plurality of fourth light-emitting elements and another one of the plurality of sixth light-emitting elements.

In an embodiment of the disclosure, the light guide plate of the light source module has a first portion and a second portion connected to each other. The first portion is provided with the light incident surface. The second portion is located on one side of the first portion facing away from the light incident surface. In a direction perpendicular to the first surface and the second surface, the first portion and the second portion respectively have a first thickness and a second thickness. The first thickness is greater than the second thickness.

In an embodiment of the disclosure, the first portion of the light guide plate of the light source module has a connecting portion connected to the second portion. The connecting portion has a thickness along the direction perpendicular to the first surface and the second surface. The thickness of the connecting portion decreases from the first thickness to the second thickness along a direction away from the light incident surface.

In an embodiment of the disclosure, the first portion and the second portion of the light guide plate of the light source module respectively have a first sub-surface and a second sub- surface. The first sub-surface and the second sub-surface define one of the first surface and the second surface. The first sub-surface is not coplanar with the second sub-surface.

In an embodiment of the disclosure, the first portion and the second portion of the light guide plate of the light source module further have a third sub-surface and a fourth sub-surface respectively. The third sub-surface and the fourth sub-surface define the other of the first surface and the second surface. The third sub-surface is not coplanar with the fourth sub-surface.

In an embodiment of the disclosure, the light incident surface of the light guide plate of the light source module is provided with a plurality of optical microstructures.

A display apparatus of the disclosure includes a non-emissive display panel and a light source module. The light source module is arranged overlapping the non-emissive display panel and includes a light guide plate, a first light source and a second light source. The light guide plate has a light incident surface and a first surface and a second surface connected to the light incident surface and opposite to each other. The first light source is disposed on one side of the light incident surface of the light guide plate and includes a first circuit board and a plurality of first light-emitting elements. The plurality of first light-emitting elements are disposed on a first board surface of the first circuit board and are adapted to emit a first light beam toward the light incident surface. The second light source is disposed on one side of the light incident surface of the light guide plate and includes a second circuit board and a plurality of second light-emitting elements. The plurality of second light-emitting elements are disposed on a second board surface of the second circuit board and are adapted to emit a second light beam toward the light incident surface. The plurality of first light-emitting elements and the plurality of second light-emitting elements are located between the first circuit board and the second circuit board. The first circuit board extends to one side of the first surface of the light guide plate so that the first board surface faces the first surface. The second circuit board extends to one side of the second surface of the light guide plate so that the second board surface faces the second surface.

In an embodiment of the disclosure, the non-emissive display panel of the display apparatus has a display surface. The light source module is disposed on one side of the display surface of the non-emissive display panel.

In an embodiment of the disclosure, the non-emissive display panel of the display apparatus has a display surface. The light source module is disposed on one side of the non- emissive display panel facing away from the display surface.

Based on the above, in a display apparatus according to an embodiment of the disclosure, a light source module is provided a first light source and a second light source on one side of a light incident surface of the light guide plate. Since the plurality of light-emitting elements of the first light source may overlap the plurality of light-emitting elements of the second light source, the density of configure of the light-emitting elements on one side of the light incident surface of the light guide plate may be greatly improved and the light beams emitted by the plurality of light- emitting elements may mix more uniformly.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display apparatus according to a first embodiment of the disclosure.

FIG. 2 is a schematic diagram of a light source module of FIG. 1.

FIG. 3 is a schematic cross-sectional view of a display apparatus according to a second embodiment of the disclosure.

FIG. 4 is a schematic diagram of a light source module of FIG. 3.

FIG. 5 is a schematic cross-sectional view of a display apparatus according to a third embodiment of the disclosure.

FIG. 6 is a schematic cross-sectional view of a light source module according to a fourth embodiment of the disclosure.

FIG. 7 is a schematic diagram of the light source module of FIG. 6.

FIG. 8 is a schematic diagram of a light source module according to a fifth embodiment of the disclosure.

FIG. 9 is a schematic diagram of a light source module according to a sixth embodiment of the disclosure.

FIG. 10 is a schematic diagram of a light source module according to a seventh embodiment of the disclosure.

FIG. 11 is a schematic diagram of a light source module according to an eighth embodiment of the disclosure.

FIG. 12 is a schematic cross-sectional view of a light source module according to a ninth embodiment of the disclosure.

FIG. 13 is a schematic cross-sectional view of a light source module according to a tenth embodiment of the disclosure.

FIG. 14 is a schematic diagram of a light source module according to an eleventh embodiment of the disclosure.

### DESCRIPTION OF THE EMBODIMENTS

The aforementioned technical contents, features and effects of the present invention will be clearly presented in the following detailed description of a preferred embodiment with reference to the drawings. The directional terms used in the following embodiments, such as up, down, left, right, front, or rear, are for reference to the directions indicated in the accompanying drawings.

Therefore, these directional terms are used for explanation purposes and not for limiting the scope of the invention.

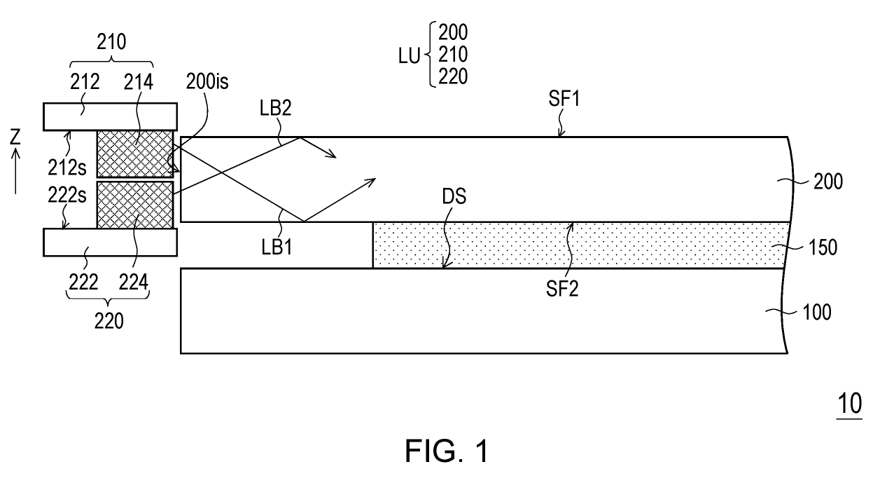

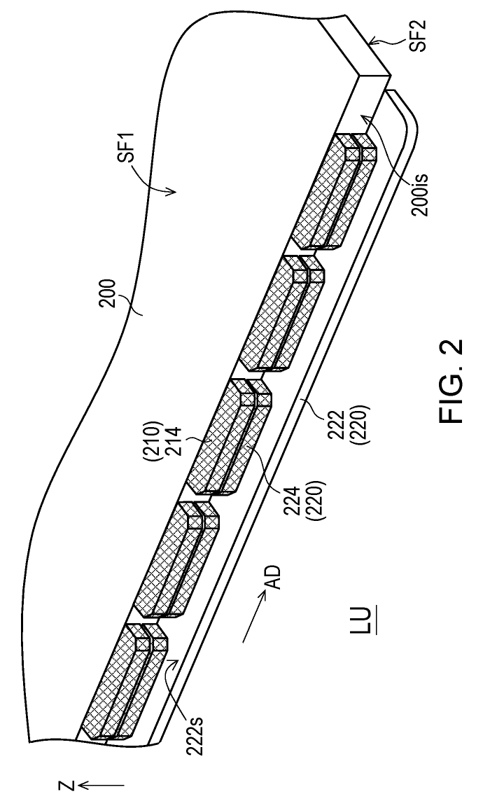

FIG. 1 is a schematic cross-sectional view of a display apparatus according to a first embodiment of the disclosure. FIG. 2 is a schematic diagram of a light source module of FIG. 1. For clarity, FIG. 2 omits the illustration of the first circuit board 212 of FIG. 1. Referring to FIG. 1 and FIG. 2, a light source module LU includes a light guide plate 200, a first light source 210, and a second light source 220. The light guide plate 200 has a light incident surface 200is and a first surface SF1 and a second surface SF2 connected to the light incident surface 200is and opposite to each other. The first light source 210 and the second light source 220 are disposed on one side of the light incident surface 200is of the light guide plate 200.

In detail, the first light source 210 includes a first circuit board 212 and a plurality of light-emitting elements 214. The light-emitting elements 214 are arranged on a first board surface 212s of the first circuit board 212 along an arrangement direction AD, and are adapted to emit a light beam LB 1 toward the light incident surface 200is, wherein the arrangement direction AD is parallel to the light incident surface 200is, the first surface SF1, and the second surface SF2 of the light guide plate 200. The second light source 220 includes a second circuit board 222 and a plurality of light-emitting elements 224. The light-emitting elements 224 are arranged on a second board surface 222s of the second circuit board 222 along the arrangement direction AD, and are adapted to emit a light beam LB2 toward the light incident surface 200is. In the embodiment, a light-emitting surface of the light-emitting element 214 may be substantially perpendicular to the first board surface 212s, and a light-emitting surface of the light-emitting element 224 may be substantially perpendicular to the second board surface 222s. It is particularly noted that the plurality of light-emitting elements 214 of the first light source 210 and the plurality of light-emitting elements 224 of the second light source 220 are located between the first circuit board 212 and the second circuit board 222, and the plurality of light-emitting elements 214 overlap the plurality of light-emitting elements 224 along a direction (e.g., direction Z) perpendicular to the first board surface 212s and the second board surface 222s.

In other words, the plurality of light-emitting elements 214 of the first light source 210 and the plurality of light-emitting elements 224 of the second light source 220 are stacked facing each other between the first circuit board 212 and the second circuit board 222. Accordingly, the density of configuration of light-emitting elements on one side of the light incident surface 200is of the light guide plate 200 can be greatly increased. In addition to meeting the light output requirements of high brightness, the light output uniformity of the light beams emitted by these light-emitting elements on the light output surface of the light guide plate 200 can also be effectively improved, thereby avoiding the hotspot effect commonly in conventional light source modules.

For example, in the embodiment, each light-emitting element 214 of the first light source 210 may overlap with a light-emitting element 224 of the second light source 220 along the direction Z, but the disclosure is not limited thereto. In the embodiment, the light source module LU may serve as an illumination light source of the non-emissive display panel 100 and constitute

a display apparatus 10. For example, the non-emissive display panel 100 may be a reflective liquid crystal display panel or an electrophoretic display panel, and the light source module LU may be attached to a display surface DS of the non-emissive display panel 100 via an adhesive layer 150 and serve as a front light module of the non-emissive display panel 100, but the disclosure is not limited thereto. Therefore, in the embodiment, the second surface SF2 of the light guide plate 200 facing the display surface DS may serve as a light output surface of the light source module LU.

Other embodiments will be listed below to explain the present disclosure in detail, wherein the same components will be marked with the same symbols, and the description of the same technical content will be omitted. For the omitted parts, please refer to the aforementioned embodiments and will not be repeated below.

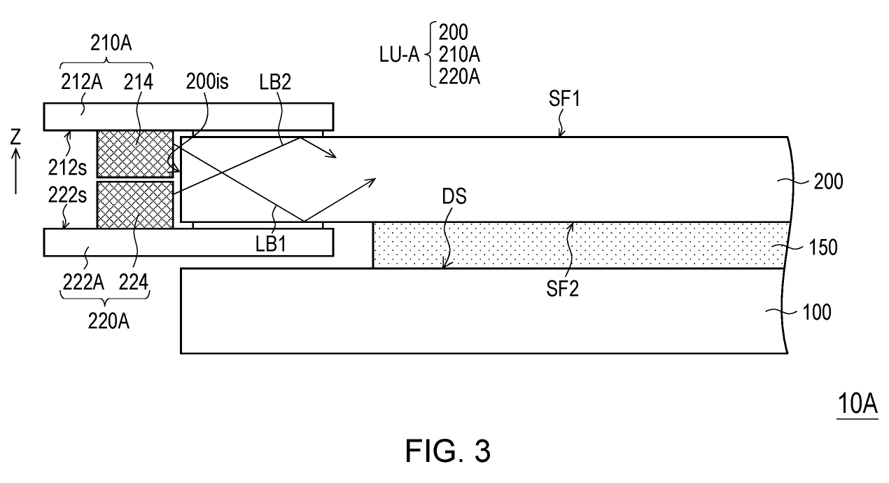

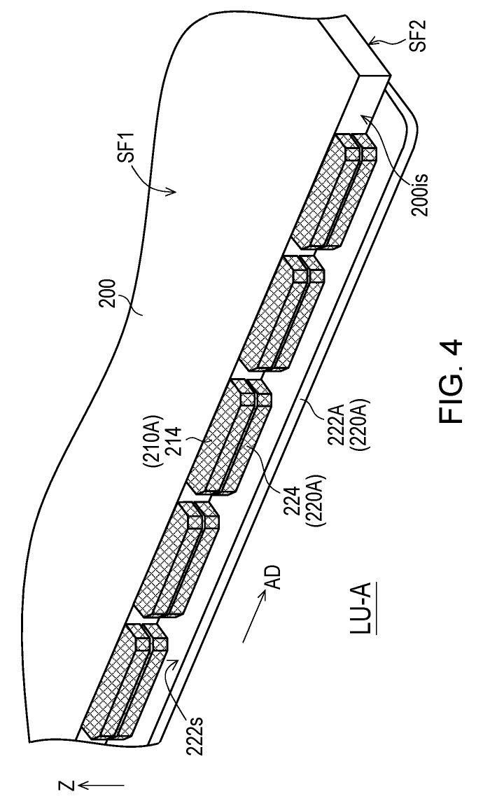

FIG. 3 is a schematic cross-sectional view of a display apparatus according to a second embodiment of the disclosure. FIG. 4 is a schematic diagram of a light source module of FIG. 3.

For clarity, FIG. 4 omits the illustration of the first circuit board 212A of FIG. 3. Referring to FIG. 3 and FIG. 4, the difference between a display apparatus 10A of the embodiment and the display apparatus 10 of FIG. 1 lies in that the circuit board is configured differently relative to the light guide plate. Specifically, in a light source module LU-A of the embodiment, the first circuit board 212A of the first light source 210A can extend to one side of the first surface SF1 of the light guide plate 200 so that the first board surface 212s faces the first surface SF1, and the second circuit board 222A of the second light source 220A can extend to one side of the second surface SF2 of the light guide plate 200 so that the second board surface 222s faces the second surface SF2.

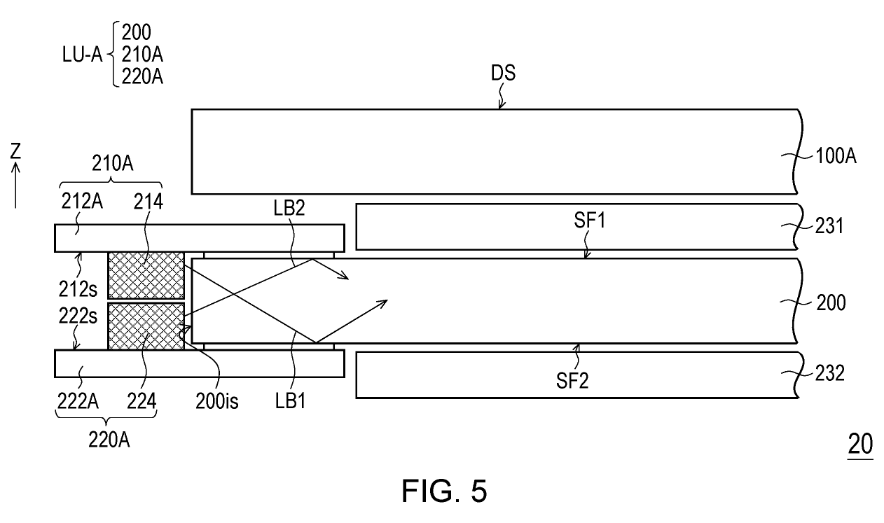

FIG. 5 is a schematic cross-sectional view of a display apparatus according to a third embodiment of the disclosure. Referring to FIG. 5, the difference between a display apparatus 20 of the embodiment and the display apparatus 10A of FIG. 3 lies in that the type of display panel and the configuration of the light source module are different. For example, in the display apparatus 20 of the embodiment, the non-emissive display panel 100A is, for example, a transmissive liquid crystal display panel, and the light source module LU-A is disposed on one side of the non-emissive display panel 100A facing away from the display surface DS. In other words, the light source module LU-A may serve as a backlight module of the non-emissive display panel 100A. Therefore, in the embodiment, the first surface SF1 of the light guide plate 200 facing the non-emissive display panel 100A may serve as the light output surface of the light source module LU-A.

In the embodiment, the light source module LU- A may be provided with an optical film 231 and an optical film 232 on both sides of the first surface SF1 and the second surface SF2 of the light guide plate 200, respectively. The optical film 231 is located between the non-emissive display panel 100A and the light guide plate 200. The optical film 232 is located on one side of the light guide plate 200 facing away from the non-emissive display panel 100A. For example, in order to meet different light output requirements, the optical film 231 may be a prism sheet, an optical brightness enhancement film, a diffuser sheet, or a combination thereof, and the optical film 232 may be a reflective sheet to improve the light energy utilization efficiency of the light source, but the disclosure is not limited thereto.

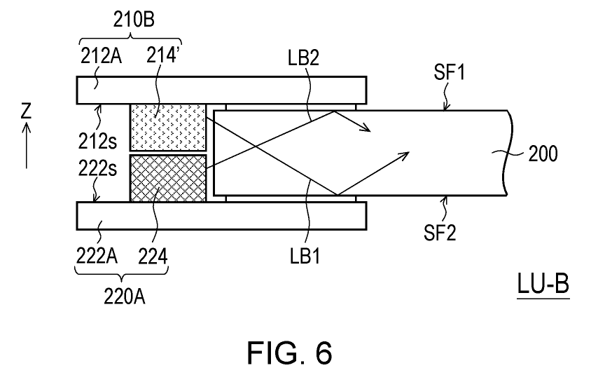

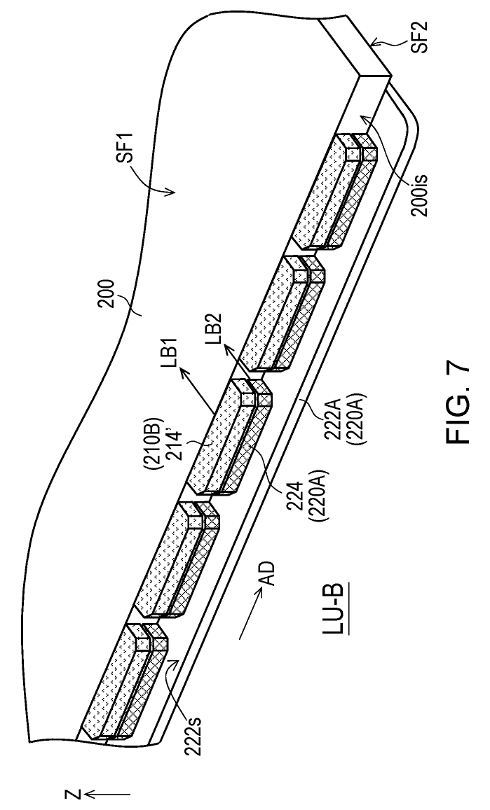

FIG. 6 is a schematic cross-sectional view of a light source module according to a fourth embodiment of the disclosure. FIG. 7 is a schematic diagram of the light source module of FIG. 6. For clarity, FIG. 7 omits the illustration of the first circuit board 212A of FIG. 6. Referring to FIG. 6 and FIG. 7, unlike the light source module LU-A of FIG. 3, the light color of the light- emitting element 214' of the first light source 210B of the light source module LU-B of the embodiment is different from the light color of the light-emitting element 224 of the second light source 220A. That is, the color of the light beam LB 1 may be different from the color of the light beam LB2.

For example, the light beam LB 1 emitted by the light-emitting element 214' may have a warm color, and the light beam LB2 emitted by the light-emitting element 224 may have a cool color. In other embodiments, the light beam LB 1 emitted by the light-emitting element 214' may have a cool color, and the light beam LB2 emitted by the light-emitting element 224 may have a warm color. Through the overlapping configuration of the light-emitting element 214' and the light-emitting element 224 in a direction (e.g., direction Z) perpendicular to the first surface SF1 and the second surface SF2, the light beam LB 1 and the light beam LB2, which have brightness and color differences, can be more evenly mixed within the light guide plate 200.

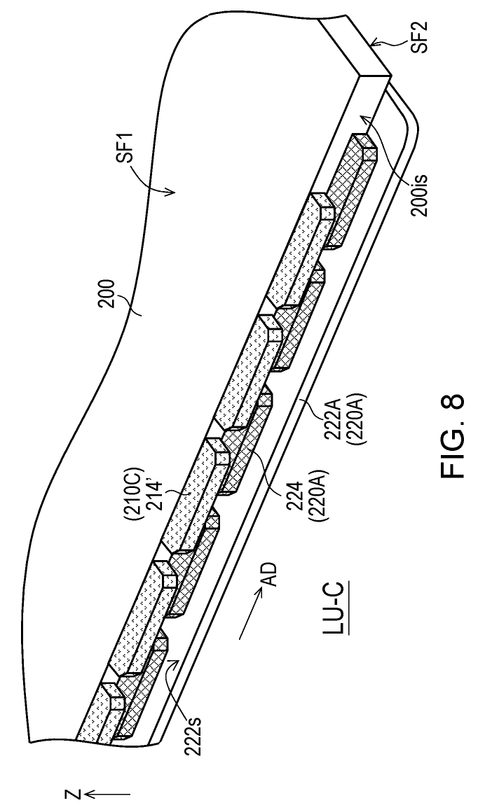

FIG. 8 is a schematic diagram of a light source module according to a fifth embodiment of the disclosure. For clarity, FIG. 8 omits the illustration of the first circuit board of the first light source. Referring to FIG. 8, the difference between a light source module LU-C of the embodiment and the light source module LU-B of FIG. 7 lies in that the plurality of light-emitting elements of the two light sources overlap in a different manner. Specifically, in the light source module LU-C of the embodiment, the plurality of light-emitting elements 214' of the first light source 210C overlap and are staggered from the plurality of light-emitting elements 224 of the second light source 220A in a direction (e.g., direction Z) perpendicular to the first surface SF1 and the second surface SF2.

For example, in the embodiment, any one of the plurality of light-emitting elements 214' overlap two adjacent ones of the plurality of light-emitting elements 224 along the direction Z, and any one of the plurality of light-emitting elements 224 overlap two adjacent ones of the plurality of light-emitting elements 214' along the direction Z. In other words, the light-emitting elements 214' of the first light source 210C and the light-emitting elements 224 of the second light source 220A are alternately arranged along the arrangement direction AD. Through this overlapping configuration, in addition to increasing the density of configuration of the light- emitting elements on one side of the light incident surface 200is of the light guide plate 200, the light beam LB 1 and the light beam LB2, which have brightness and color differences, can be more evenly mixed within the light guide plate 200, thereby improving the uniformity of light output of the light source module LU-C.

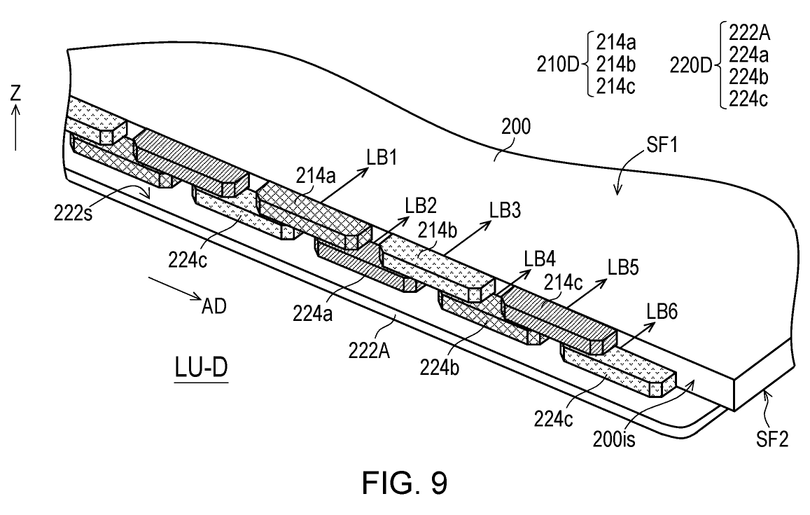

FIG. 9 is a schematic diagram of a light source module according to a sixth embodiment of the disclosure. FIG. 9 omits the illustration of the first circuit board of the first light source.

Referring to FIG. 9, the difference between a light source module LU-D of the embodiment and the light source module LU-C of FIG. 8 only lies in that the composition of the light-emitting elements of the light source is different.

For example, in the embodiment, the first light source 210D may include a plurality of light-emitting elements 214a, a plurality of light-emitting elements 214b, and a plurality of light- emitting elements 214c alternately arranged on a first board surface of a first circuit board (not shown) along an arrangement direction AD. The second light source 220D may include a plurality of light-emitting elements 224a, a plurality of light-emitting elements 224b, and a plurality of light-emitting elements 224c alternately arranged on a second board surface 222s of the second circuit board 222A along the arrangement direction AD. The light-emitting elements 214a, 224a, 214b, 224b, 214c, and 224c are adapted to emit a light beam LB1, a light beam LB2, a light beam LB3, a light beam LB4, a light beam LB5, and a light beam LB6 respectively toward the light incident surface 200is of the light guide plate 200.

In a direction (e.g., direction Z) perpendicular to the first board surface and the second board surface 222s, the light-emitting element 214a may overlap the light-emitting element 224a and the light-emitting element 224c, the light-emitting element 214b may overlap the light- emitting element 224a and the light-emitting element 224b, and the light-emitting element 214c may overlap the light-emitting element 224b and the light-emitting element 224c. More specifically, the plurality of light-emitting elements 214a, the plurality of light-emitting elements 214b, and the plurality of light-emitting elements 214c of the first light source 210D and the plurality of light-emitting elements 224a, the plurality of light-emitting elements 224b, and the plurality of light-emitting elements 224c of the second light source 220D are alternately arranged along the arrangement direction AD.

On the other hand, in the embodiment, the colors of the light beam LB 1, the light beam LB3, and the light beam LBS emitted by the first light source 210D may be different from each other, and the colors of the light beam LB2, the light beam LB4, and the light beam LB6 emitted by the second light source 220D may be different from each other. For example, the light colors of the light-emitting element 214a and the light-emitting element 224b may be the same as each other, the light colors of the light-emitting element 214b and the light-emitting element 224c may be the same as each other, and the light colors of the light-emitting element 214c and the light- emitting element 224a may be the same as each other. That is, the color of the light beam LB 1 may be the same as the color of the light beam LB4, the color of the light beam LB2 may be the same as the color of the light beam LB5, and the color of the light beam LB3 may be the same as the color of the light beam LB6.

Through the above-mentioned overlapping configuration, in addition to increasing the density of configuration of the light-emitting elements on one side of the light incident surface 200is of the light guide plate 200, the light beams LB1, LB2 and LB3 (or light beams LB4, LB5 and LB6), which have brightness and color differences, can be more evenly mixed within the light guide plate 200, thereby improving the uniformity of light output of the light source module LU- D.

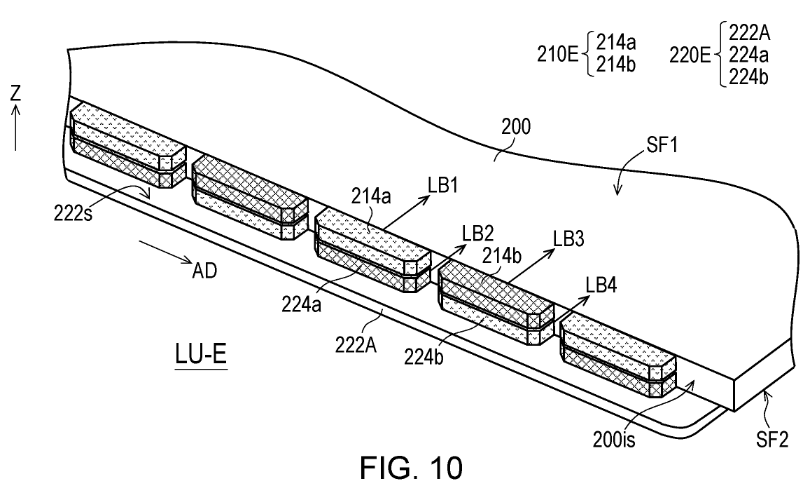

FIG. 10 is a schematic diagram of a light source module according to a seventh embodiment of the disclosure. FIG. 10 omits the illustration of the first circuit board of the first light source. Referring to FIG. 10, the difference between a light source module LU-E of the embodiment and the light source module LU-B of FIG. 7 lies in that the composition of the light- emitting elements of the light source is different.

For example, in the embodiment, the first light source 210E may include a plurality of light-emitting elements 214a and a plurality of light-emitting elements 214b alternately arranged on a first board surface of a first circuit board (not shown) along an arrangement direction AD.

The second light source 220E may include a plurality of light-emitting elements 224a and a plurality of light-emitting elements 224b alternately arranged on the second board surface 222s of the second circuit board 222A along the arrangement direction AD. The light-emitting elements 214a, 224a, 214b and 224b are adapted to emit a light beam LB 1, a light beam LB2, a light beam LB3 and a light beam LB4 respectively toward the light incident surface 200is of the light guide plate 200.

In a direction (e.g., direction Z) perpendicular to the first board surface and the second board surface 222s, the light-emitting element 214a may overlap the light-emitting element 224a, and the light-emitting element 214b may overlap the light-emitting element 224b. On the other hand, in the embodiment, the colors of the light beam LB 1 and the light beam LB3 emitted by the first light source 210E may be different from each other, and the colors of the light beam LB2 and the light beam LB4 emitted by the second light source 220E may be different from each other.

For example, the light colors of the light-emitting element 214a and the light-emitting element 224b may be the same, and the light colors of the light-emitting element 214b and the light- emitting element 224a may be the same. That is, the color of the light beam LB 1 may be the same as the color of the light beam LB4, and the color of the light beam LB2 may be the same as the color of the light beam LB3.

Through the above-mentioned overlapping configuration, in addition to increasing the density of configuration of the light-emitting elements on one side of the light incident surface 200is of the light guide plate 200, the light beam LB 1 (or light beam LB4) and the light beam LB3 (or light beam LB2), which have brightness and color differences, can be more evenly mixed within the light guide plate 200, thereby improving the uniformity of light output of the light source module LU-E.

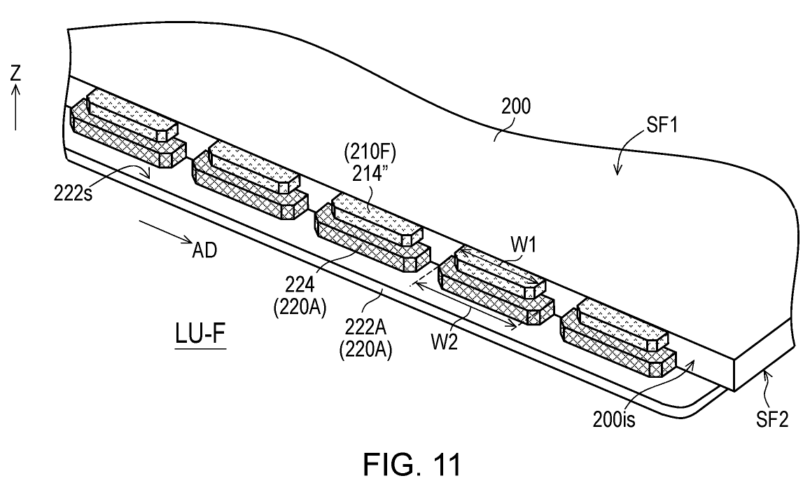

FIG. 11 is a schematic diagram of a light source module according to an eighth embodiment of the disclosure. FIG. 11 omits the illustration of the first circuit board of the first light source. Referring to FIG. 11, the difference between a light source module LU-F of the embodiment and the light source module LU-B of FIG. 7 only lies in that the type of light-emitting element of the first light source is different. Specifically, in the light source module LU-F of the embodiment, the packaging structure of the light-emitting element 214" of the first light source 210F may be different from the packaging structure of the light-emitting element 224 of the second light source 220A. For example, an element width W1 of the light-emitting element 214" along the arrangement direction AD may be different from an element width W2 of the light-emitting element 224 along the arrangement direction AD. It should be understood that in other variant embodiments, the plurality of light-emitting elements of the same light source may have different packaging structures.

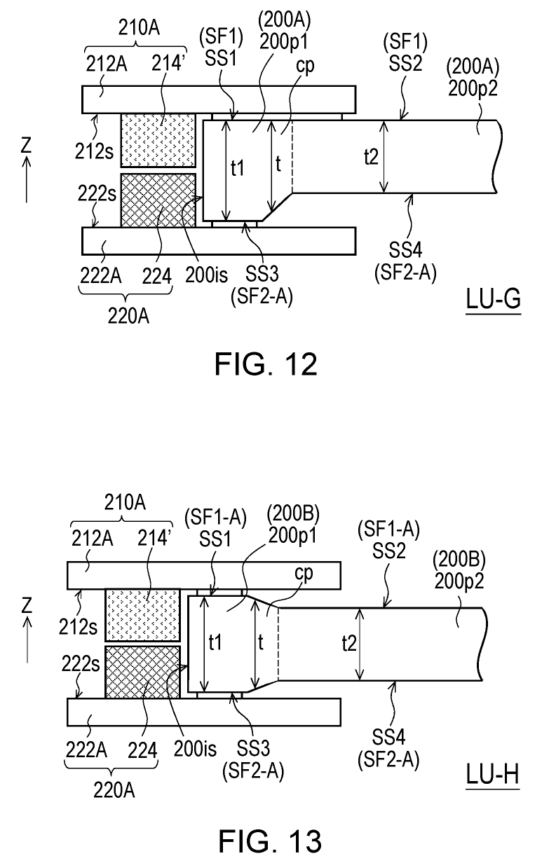

FIG. 12 is a schematic cross-sectional view of a light source module according to a ninth embodiment of the disclosure. FIG. 13 is a schematic cross-sectional view of a light source module according to a tenth embodiment of the disclosure. Referring to FIG. 12, the difference between a light source module LU-G of the embodiment and the light source module LU-B of FIG. 6 only lies in that the configuration of the light guide plate is different. Specifically, in the light source module LU-G of the embodiment, the light guide plate 200A has a first portion 200p1 and a second portion 200p2 connected to each other. The first portion 200pl is provided with the light incident surface 200is. The first portion 200p1 has a connecting portion cp connected to the second portion 200p2. The second portion 200p2 is located on one side of the first portion 200pl facing away from the light incident surface 200is.

It is particularly noted that in a direction (e.g., direction Z) perpendicular to the first surface SF1 and the second surface SF2, the first portion 200pl and the second portion 200p2 have a thickness tl and a thickness t2, respectively, and the thickness tl is greater than the thickness t2. The connecting portion cp has a thickness t, and the thickness t of the connecting portion cp decreases from the thickness tl to the thickness t2 along a direction away from the light incident surface 200is.

From another point of view, the first portion 200p l and the second portion 200p2 of the light guide plate 200A respectively have a sub-surface SS1 and a sub-surface SS2 defining the first surface SF1, and respectively have a sub-surface SS3 and a sub-surface SS4 defining the second surface SF2-A. For example, in the embodiment, the sub-surface SS1 of the first portion 200pl and the sub-surface SS2 of the second portion 200p2 are coplanar, and the sub-surface SS3 of the first portion 200pl and the sub-surface SS4 of the second portion 200p2 are not coplanar.

In other words, the light guide plate 200A of the light source module LU-G presents an asymmetric trumpet-shaped structure in cross-section on one side of the light incident surface 200is.

However, the disclosure is not limited thereto. In other variant embodiments, the sub- surface SS1 of the first portion 200p i may not be coplanar with the sub-surface SS2 of the second portion 200p2, and the sub-surface SS3 of the first portion 200pi may be coplanar with the sub- surface SS4 of the second portion 200p2.

The light guide plate 200A of the embodiment has a trumpet-shaped structure on one side of the light incident surface 200is, and the second portion 200p2 thereof is thinner than the first portion 200p1. Therefore, the overall thickness of the light source module LU-G can be reduced.

However, the disclosure is not limited thereto. Referring to FIG. 13, in another embodiment of a light source module LU-H, in addition to the sub-surface SS3 and the sub-surface SS4 defining the second surface SF2-A of the light guide plate 200B not being coplanar, the sub- surface SS1 and the sub-surface SS2 defining the first surface SF1-A of the light guide plate 200B may also not be coplanar. From the cross-sectional view, the structure of the light guide plate 200B of the light source module LU-H on one side of the light incident surface 200is has a relatively symmetrical trumpet-shaped contour.

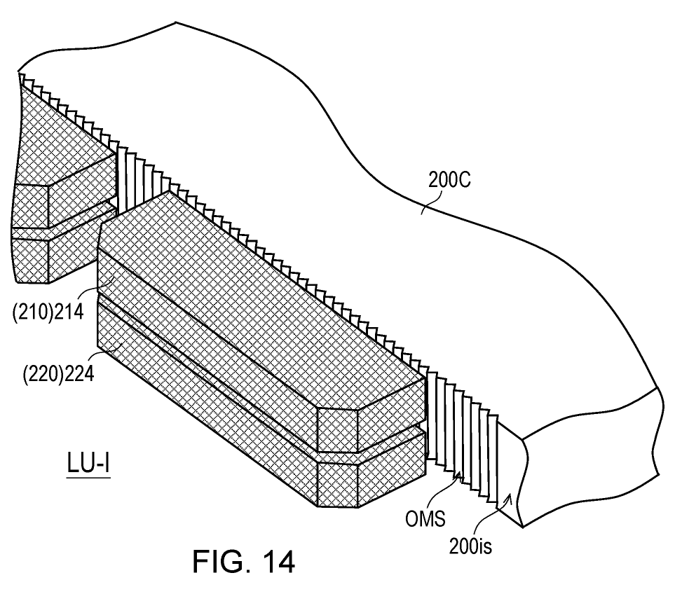

FIG. 14 is a schematic diagram of a light source module according to an eleventh embodiment of the disclosure. FIG. 14 omits the illustration of the first circuit board of the first light source and the second circuit board of the second light source. Referring to FIG. 14, the difference between a light source module LU-I of the embodiment and the light source module LU of FIG. 2 only lies in that the configuration of the light incident surface of the light guide plate is different. For example, in the light source module LU-I of the embodiment, the light incident surface 200is of the light guide plate 200C may be provided with a plurality of optical microstructures OMS. Through the configuration of the optical microstructures OMS, the light beams emitted by the light-emitting elements can be more evenly mixed near the light incident surface 200is of the light guide plate 200C, thereby further improving the uniformity of light output of the light source module LU-I.

To sum up, in a display apparatus according to an embodiment of the disclosure, a light source module is provided a first light source and a second light source on one side of a light incident surface of the light guide plate. Since the plurality of light-emitting elements of the first light source may overlap the plurality of light-emitting elements of the second light source, the density of configure of the light-emitting elements on one side of the light incident surface of the light guide plate may be greatly improved and the light beams emitted by the plurality of light- emitting elements may mix more uniformly.

It will be apparent to those skilled in the art that various modifications and variations can be made to the disclosed embodiments without departing from the scope or spirit of the disclosure.

In view of the foregoing, it is intended that the disclosure covers modifications and variations provided that they fall within the scope of the following claims and their equivalents.

What is claimed is:

1. A light source module, comprising:
a light guide plate, having a light incident surface and a first surface and a second surface connected to the light incident surface and opposite to each other;
a first light source, disposed on one side of the light incident surface of the light guide plate,
and comprising a first circuit board and a plurality of first light-emitting elements, wherein the plurality of first light-emitting elements are disposed on a first board surface of the first circuit board and are adapted to emit a first light beam toward the light incident surface; anda second light source, disposed on one side of the light incident surface of the light guide
plate, and comprising a second circuit board and a plurality of second light-emitting elements,
wherein the plurality of second light-emitting elements are disposed on a second board surface of the second circuit board and are adapted to emit a second light beam toward the light incident surface,wherein the plurality of first light-emitting elements and the plurality of second light-emitting
elements are located between the first circuit board and the second circuit board.

2. The light source module according to claim 1, wherein in a direction perpendicular to the first board surface and the second board surface, the plurality of first light-emitting elements overlap the plurality of second light-emitting elements respectively.

3. The light source module according to claim 1, wherein in a direction perpendicular to the
first board surface and the second board surface, one of the plurality of first light-emitting elements overlaps one of the plurality of second light-emitting elements, and the one of the plurality of first light-emitting elements is staggered relative to the one of the plurality of second light-emitting elements.

4. The light source module according to claim 3, wherein the one of the plurality of first light-
emitting elements also overlaps another one of the plurality of second light-emitting elements, and
the one of the plurality of second light-emitting elements also overlaps another one of the plurality of first light-emitting elements.

5. The light source module according to claim 1, wherein a color of the first light beam is different from a color of the second light beam.

6. The light source module according to claim 1, wherein the first circuit board extends to one side of the first surface of the light guide plate so that the first board surface faces the first surface, and the second circuit board extends to one side of the second surface of the light guide plate so that the second board surface faces the second surface.

7. The light source module according to claim 1, wherein the plurality of first light-emitting
elements are arranged along an arrangement direction parallel to the light incident surface, the first surface and the second surface, the plurality of second light-emitting elements are arranged along the arrangement direction, in the arrangement direction, any one of the plurality of first light- emitting elements and any one of the plurality of second light-emitting elements respectively have a first element width and a second element width, and the first element width is different from the second element width.

8. The light source module according to claim 1, wherein the first light source further comprises:
a plurality of third light-emitting elements, disposed on the first board surface of the first circuit board, and are adapted to emit a third light beam toward the light incident surface, the
plurality of first light-emitting elements and the plurality of third light-emitting elements are alternately arranged along an arrangement direction parallel to the light incident surface, the first surface and the second surface, the second light source further comprises:a plurality of fourth light-emitting elements, disposed on the second board surface of the second circuit board, and are adapted to emit a fourth light beam toward the light incident surface, the plurality of second light-emitting elements and the plurality of fourth light-emitting elements
are alternately arranged along the arrangement direction, a color of the third light beam is different from a color of the first light beam, and a color of the fourth light beam is different from a color of the second light beam.

9. The light source module according to claim 8, wherein in a direction perpendicular to the
first board surface and the second board surface, the plurality of first light-emitting elements overlap the plurality of second light-emitting elements respectively, the plurality of third light- emitting elements overlap the plurality of fourth light-emitting elements respectively, the color of the first light beam is different from the color of the second light beam, and the color of the third light beam is different from the color of the fourthlight beam.

10. The light source module according to claim 9, wherein the color of the first light beam is the same as the color of the fourth light beam, and the color of the second light beam is the same as the color of the third light beam.

11. Thelight source module according to claim 8, wherein the first light source further comprises:
a plurality of fifth light-emitting elements, disposed on the first board surface of the first circuit board, and are adapted to emit a fifth light beam toward the light incident surface, the plurality of first light-emitting elements, the plurality of third light-emitting elements and the plurality of fifth light-emitting elements are alternately arranged along the arrangement direction,
the second light source further comprises:a plurality of sixth light-emitting elements, disposed on the second board surface of the second circuit board, and are adapted to emit a sixth light beam toward the light incident surface, the plurality of second light-emitting elements, the plurality of fourth light-emitting elements and the plurality of sixth light-emitting elements are alternately arranged along the arrangement direction, a color of the fifth light beam is different from the color of the first light beam and the
color of the third light beam, and a color of the sixth light beam is different from the color of the
second light beam and the color of the fourth light beam.

12. The light source module according to claim 11, wherein in a direction perpendicular to the first board surface and the second board surface, one of the plurality of first light-emitting elements overlaps one of the plurality of second light-emitting elements and one of the plurality
of sixth light-emitting elements, one of the plurality of third light-emitting elements overlaps the one of the plurality of second light-emitting elements and one of the plurality of fourth light- emitting elements, and one of the plurality of fifth light-emitting elements overlaps the one of the plurality of fourth light-emitting elements and another one of the plurality of sixth light-emitting elements.

13. The lightsource module according to claim 1, wherein the light guide plate has a first portion and a second portion connected to each other, the first portion is provided with the light incident surface, the second portion is located on one side of the first portion facing away from the light incident surface, in a direction perpendicular to the first surface and the second surface, the first portion and the second portion respectively have a first thickness and a second thickness, and the first thickness is greater than the second thickness.

14. The light source module according to claim 13, wherein the first portion has a connecting portion connected to the second portion, the connecting portion has a thickness along the direction perpendicular to the first surface and the second surface, and the thickness of the connecting portion decreases from the first thickness to the second thickness along a direction away from the
light incident surface.

15. The light source module according to claim 13, wherein the first portion and the second portion respectively have a first sub-surface and a second sub-surface, the first sub-surface and the second sub-surface define one of the first surface and the second surface, and the first sub- surface is not coplanar with the second sub-surface.

16. The light source module according to claim 15, wherein the first portion and the second
portion further have a third sub-surface and a fourth sub-surface respectively, the third sub-surface and the fourth sub-surface define the other of the first surface and the second surface, and the third sub-surface is not coplanar with the fourth sub-surface.

17. The light source module according to claim 1, wherein the light incident surface of the
light guide plate is provided with a plurality of optical microstructures.

18. A display apparatus, comprising:
a non-emissive display panel; and
a light source module, arranged overlapping the non-emissive display panel, and comprising:
a light guide plate, having a light incident surface and a first surface and a second surface connected to the light incident surface and opposite to each other;
a first light source, disposed on one side of the light incident surface of the light guide plate, and comprising a first circuit board and a plurality of first light-emitting elements, wherein the plurality of first light-emitting elements are disposed on a first board surface of the first circuit board and are adapted to emit a first light beam toward the light incident surface; and
a second light source, disposed on one side of the light incident surface of the light guide plate, and comprising a second circuit board and a plurality of second light-emitting elements, wherein the plurality of second light-emitting elements are disposed on a second board surface of the second circuit board and are adapted to emit a second light beam toward the light incident surface,
wherein the plurality of first light-emitting elements and the plurality of second light- emitting elements are located between the first circuit board and the second circuit board, the first circuit board extends to one side of the first surface of the light guide plate so that the first board surface faces the first surface, and the second circuit board extends to one side of the second surface of the light guide plate so that the second board surface faces the second surface.

19. The display apparatus according to claim 18, wherein the non-emissive display panel has
a display surface, and the light source module is disposed onone side of the display surface of the non-emissive display panel.

20. The display apparatus according to claim 18, wherein the non-emissive display panel has a display surface, and the light source module is disposed onone side of the non-emissive display
panel facing away fron the display surface.
